(19) United States
(12) Patent Application Publication
(10) Pub. No.: US 2024/0410535 A1
(43) Pub. Date: Dec. 12, 2024

(54) SELF-ILLUMINATION VEHICLE CANOPY

(71) Applicant: TEXTRON, INC., Providence, RI (US)

(72) Inventors: Paul Edward Morgan, Appling, GA (US); Jacob Rutledge Kuglar, Martinez, GA (US); Stephen Christoper Campbell, Augusta, GA (US)

(21) Appl. No.: 18/329,719

(22) Filed: Jun. 6, 2023

(51) Int. Cl. F21K 2/00; B62D 25/06; C09D 5/22; C09K 11/58; C09K 11/64

(52) U.S. Cl. CPC F21K 2/00; B62D 25/06; C09D 5/22; C09K 11/584; C09K 11/643

(57) ABSTRACT

A canopy for a vehicle, wherein the canopy comprises a body that is structured and operable to protect passengers of the vehicle from rain, water and sunlight, wherein the body comprises a photoluminescent material that is structured and operable to illuminate in the absence of light such that the body is structured and operable to self-illuminate without a connection to an electrical power source.

### FIELD

The present teachings relate to vehicle canopies, and more particularly to a self-illumination canopy.

### BACKGROUND

The statements in this section merely provide background information related to the present disclosure and may not constitute prior art.

Vehicles, such as maintenance vehicles, cargo vehicles, shuttle vehicles, golf cars, all-terrain vehicles (ATVs), utility-terrain vehicles (UTVs), worksite vehicles, buggies or any other type of utility or low-speed vehicle, are often used and operated early in the morning or later in the evening when natural light (e.g., sunlight) and/or cast light (e.g., artificial lighting) is not available. In such instances, the vehicle must be equipped with a light source that is typically an electrically generated light source, such as one or more light bulb or LED, that relies on an electrical power source, such as one or more battery, to produce or generate light. Such known light sources and corresponding power sources require maintenance, and add costs and complexity to the respective vehicles.

### SUMMARY

In various embodiments, the present disclosure provides a canopy for a vehicle, wherein the canopy comprises a body that is structured and operable to protect passengers of the vehicle from rain, water and sunlight, wherein the body comprises a photoluminescent material that is structured and operable to illuminate in the absence of light such that the body is structured and operable to self-illuminate without a connection to an electrical power source.

In various other embodiments, the present disclosure provides a canopy system for a vehicle, wherein the canopy system comprises at least one front strut, at least one rear strut, and a canopy that is mountable to the at least one front strut and the at least one rear strut. In various embodiments the canopy comprises a body that is structured and operable to protect passengers of the vehicle from rain, water and sunlight, wherein the body comprises a photoluminescent material that is structured and operable to illuminate in the absence of light such that the body is structured and operable to self-illuminate without a connection to an electrical power source.

In yet other various embodiments, the present disclosure provides a vehicle that comprises a chassis, a plurality of wheels operatively connected to the chassis; a passenger compartment supported by the chassis; and a canopy system structured and operable to protect passengers of the vehicle from rain, water and sunlight. In various embodiments, the canopy system comprises at least one front strut, at least one rear strut, and a canopy that is mountable to the at least one front strut and the at least one rear strut. In various embodiments the canopy comprises a body that is structured and operable to protect passengers of the vehicle from rain, water and sunlight, wherein the body comprises a photoluminescent material that is structured and operable to illuminate in the absence of light such that the body is structured and operable to self-illuminate without a connection to an electrical power source.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### DRAWINGS

The drawings described herein are for illustration purposes only and are not intended to limit the scope of the present teachings in any way.

FIG. 1A is a side view of an exemplary vehicle comprising a canopy system including a self-illuminating canopy, in accordance with various embodiments of the present disclosure.

FIG. 1B is a side view of another exemplary vehicle comprising the canopy system including a self-illuminating canopy, wherein the canopy is exemplarily illustrated to have a different size and shape, in accordance with various embodiments of the present disclosure.

FIG. 2A is an exemplary isometric exploded view of the canopy system shown in FIG. 1A including the self-illuminating canopy, in accordance with various embodiments of the present disclosure.

FIG. 2B is an exemplary isometric exploded view of the canopy system shown in FIG. 1B including the self-illuminating canopy exemplarily illustrated to have a different size and shape, in accordance with various embodiments of the present disclosure.

FIG. 3A is an exemplary isometric top view of the self-illuminating canopy shown in FIGS. 1A and 2A, in accordance with various embodiments of the present disclosure.

FIG. 3B is an exemplary isometric top view of the self-illuminating canopy shown in FIGS. 1B and 2B, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts are causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

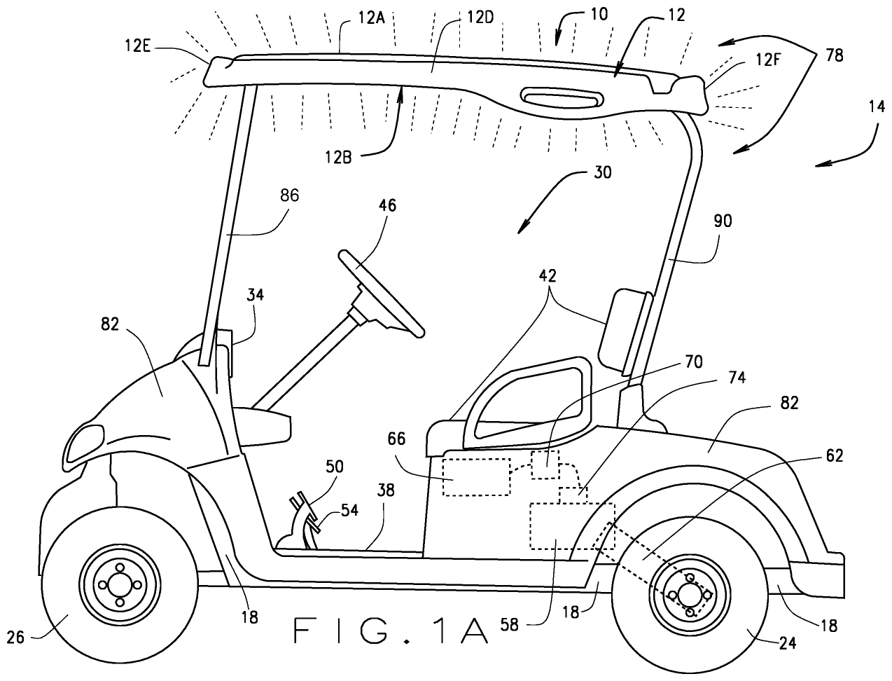

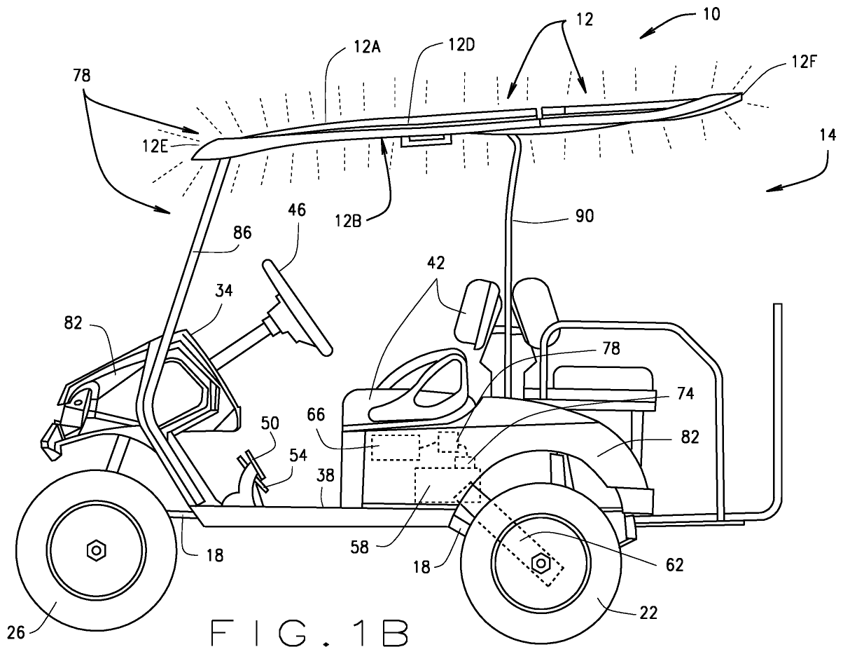

Referring now to FIGS. 1A and 1B, the present disclosure generally provides a self-illuminating canopy 10 for a vehicle 14 that is structured and operable to self-illuminate (e.g., glow-in-the-dark) in environments where surrounding light (natural are artificial lighting) is not present. Although the self-illuminating canopy 10 is exemplarily illustrated as a canopy for low-speed vehicle, e.g., a golf cart, it should be understood that the self-illuminating canopy 10 can be or comprise any roof or cover having any shape and size for any vehicle and remain within the scope of the present disclosure. The term ‘canopy’ is used herein only as an exemplary generic term for clarity and simplicity, but will be understood to include all roofs, covers and canopies, having all shapes and sizes, for all vehicles.

The self-illuminating canopy 10 can be utilized with any vehicle 14 such as a golf car, a passenger transport or shuttle vehicle, a maintenance or ground care utility vehicle, a turf mower, a cargo vehicle, or any other low-speed vehicle (e.g., a vehicle designed to travel at speeds between 0and 45 mph). The vehicle 14 generally includes a chassis or frame 18, a pair of rear wheels 22 and a pair of front wheels 26 operationally connected to the chassis 14, and a passenger compartment 30. The passenger compartment 30 generally includes a dash console 34, a floorboard 38, and a passenger seating structure 42. The dash console 34 can include one or more instrument displays, gauges, vehicle control devices and/or storage compartments. The passenger compartment 30 additionally includes a steering wheel 46 for use by the operator to control the directional movement of the vehicle 14, a brake pedal 50 for use by the operator to control slowing and stopping of the vehicle 14, and an accelerator pedal 54 for use by the operator to control the torque delivered by a prime mover 58 (described below) to one or more of the rear and/or front wheels 22 and/or 24. Particularly, the prime mover 58 is operatively connected to a drivetrain 62 that is operatively connected to at least one of the rear and/or front wheels 22 and/or 24.

The vehicle 14 further comprises a vehicle electrical power source 66 (e.g., one or more battery) that is structured and operable to provide electrical power to various electrical components of the vehicle 14 (e.g., a vehicle motor if the prime mover 58 is an electric motor, and other vehicle electrically operated modules and components), and a vehicle main control module 70 that is communicatively (wired or wirelessly) connected to a computer-based prime mover control unit (PMCU) 74. The PMCU 74 is structured and operable to control various operations of the vehicle prime mover 58 such as air/fuel ratio, spark timing and engine speed (e.g., RPM) if the prime mover 58 is an internal combustion engine, and motor speed and torque output if the prime mover 58 is an electric motor). The vehicle main control module 70 is structured and operable to communicate with the PMCU 74 and control various other vehicle modules, devices and operations. The prime mover 58 can be any device that is structured and operable to generate torque (e.g., motive force, e.g., power) utilized to provide motive force for the vehicle 14 via the drivetrain 62. For example, the prime mover 58 can be an internal combustion engine (ICE), an electric motor, a hybrid combination of an ICE and an electric motor, or any other suitable motive power source and remain within the scope of the present disclosure. Operation of the prime mover 58 is generally controlled by PMCU 74 to generate torque (e.g., motive force, e.g., power) utilized to provide motive force for the vehicle 14 via the drivetrain 62. For example, in various embodiments wherein the prime mover 58 is an internal combustion engine the PMCU 74 can control engine speed and torque output by controlling a fuel/air mixture ratio and/or a spark ignition timing of the engine. Or, for example, in various embodiments wherein the prime mover 58 is an electric motor, the PMCU 74 can control the amount of voltage provided to the motor from the electrical power source 66.

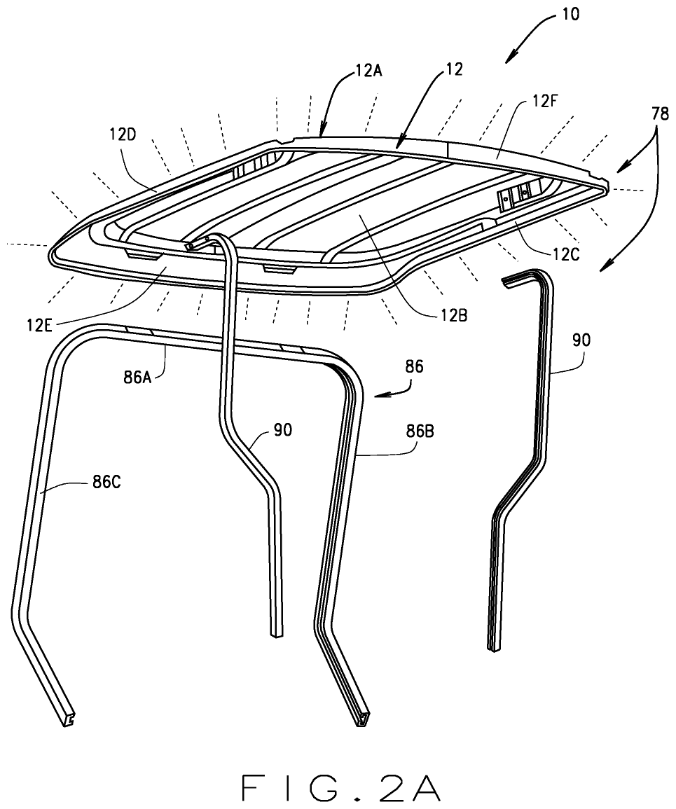

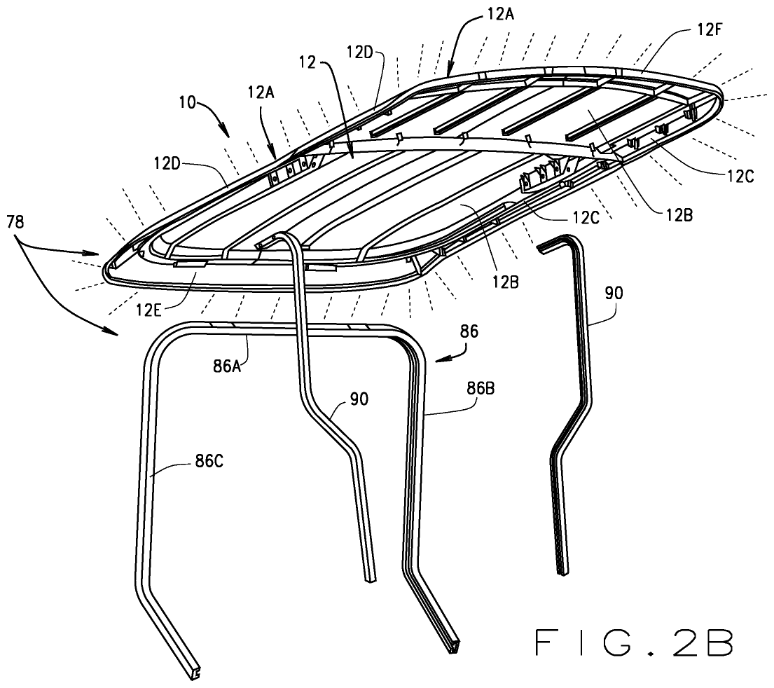

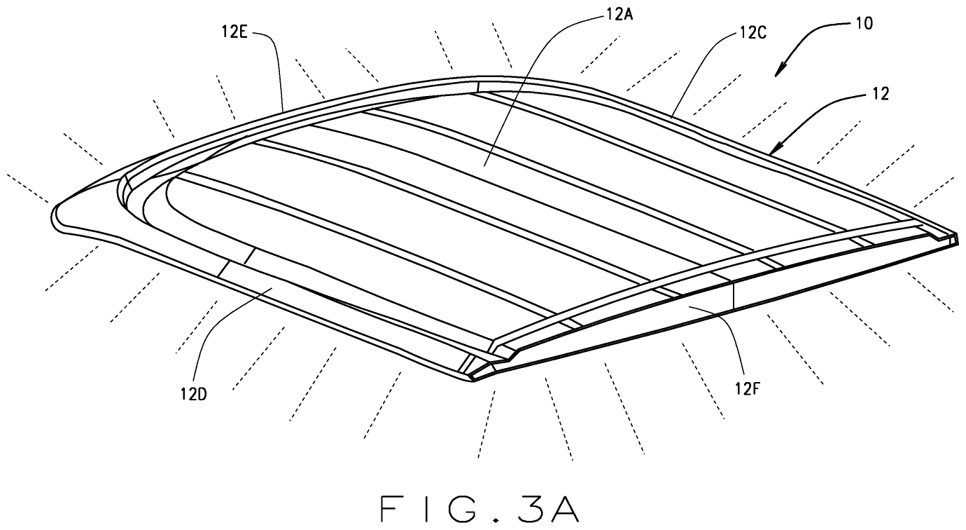

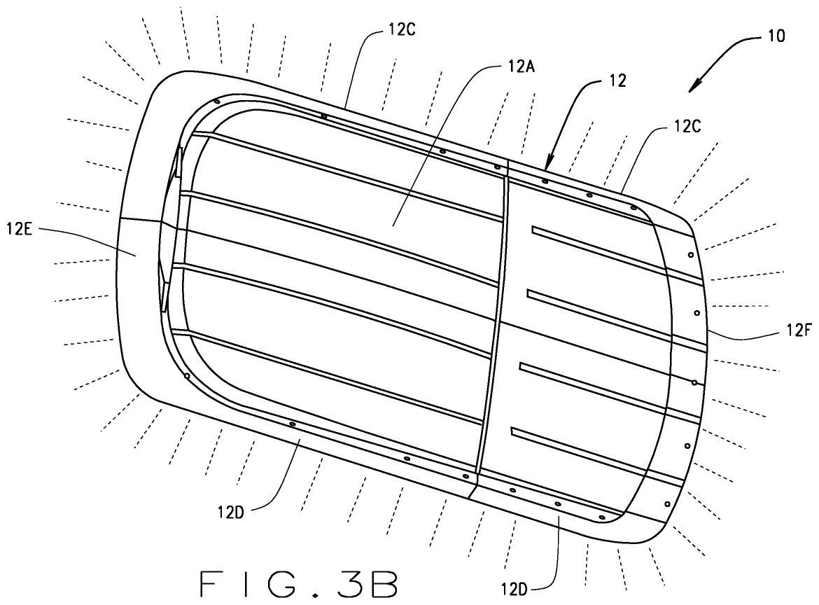

Referring now to FIGS. 1A, 1B, 2A, 1B, 3A and 3B, as described above, the vehicle 14 includes the self-illuminating canopy 10. More particularly, the vehicle 14 comprises a canopy system 78 mounted to the vehicle body 82 and/or chassis 18 and disposed over and around the passenger compartment 30. The canopy system 78 is structured and operable to protect passengers of the vehicle 14 from rain, water and sunlight, and to channel or direct water or rain or other liquid away from the passenger(s) and passenger compartment 30. In various embodiments the canopy system 78 comprises at least one front strut, column or pillar 86 that is mountable to a front cowl of the vehicle body 82 and/or the chassis 14 and/or other forward structure of the vehicle 14, at least one rear strut, column or pillar 90 that is mountable to a rear deck of the vehicle body 82 and/or the chassis 14 and/or other rearward structure of the vehicle 14, and the self-illuminating canopy 10 that is mountable to the front strut(s), column(s) or pillar(s) 86 and the rear canopy front strut(s), column(s) or pillar(s) 90. In various embodiments, the at least one front strut, column or pillar 86 can comprise a header 86A, a first leg 86B extending from, connected to and/or integrally formed with a first end of the header 86A, and a second leg 86C extending from, connected to and/or integrally formed with a second end of the header 86A.

In various embodiments, the self-illuminating canopy 10 comprises a self-illuminating body 12 having a top surface 12A, a bottom surface 12B, a first side edge or wall 12C, a second side edge or wall 12D, a front edge or wall 12E and a rear edge or wall 12F The canopy 10 is mountable to the front strut(s), column(s) or pillar(s) 86 and the rear strut(s), column(s) or pillar(s) 90 using any suitable connection method, manner, means, device, system or mechanism (e.g., clamps, nut and bolts, screws, etc.). As described above, the canopy 10, i.e., the canopy body 12, is self-luminating and will generate, produce, radiate, discharge and/or exude light without use of an electrical power source or any other power source connected to the canopy 10, and without any other light generating source (e.g., light bulbs or LEDs) connected or mounted to any part of the canopy 10. Particularly, the body 12 comprises a phosphorescent or other photoluminescent material that is structured and operable to illuminate in the absence of light such that the canopy body 12 is self-illuminating. More particularly, the self-illuminating canopy 10 generates, produces, radiates, discharges and/or exudes light using only materials, substances, metals, minerals, pigments, chemicals and/or compounds that comprise self-illuminating properties, characteristics, qualities or features and are integrally formed with the canopy body 12, are a component of the material used to fabricate the canopy by 12, are painted on the canopy body 12, or are otherwise applied to the canopy body 12 (e.g., the entire canopy body 12) as a layer or coating. For example, in various embodiments, the canopy body 12 can comprise a phosphorescent, or other photoluminescent material that is integrally formed with the material used to fabricate canopy body 12. Alternatively, in other exemplary embodiments the canopy body 12 can comprise a phosphorescent, or other photoluminescent material that is a component of, or impregnated into the material used to fabricate the canopy body 12 (e.g., a doped material). In still other exemplary embodiments, a phosphorescent, or other photoluminescent material can be painted on, or otherwise applied as a layer or coating on a substrate to provide the canopy body 12. Such a substrate can be made of any suitable and desirable material such as plastic, fiberglass, steel, aluminum, etc.

The phosphorescent or photoluminescent material can be any known or unknown ‘glow-in-the-dark’ material such that when exposed to a light source (e.g., sunlight or artificial light) will absorb the light energy or radiation from the light source and reemit the energy or radiation in the form light for a considerable amount of time after the light source is removed. For example, in various embodiments the phosphorescent or photoluminescent material can be strontium aluminate or copper-activated zinc sulfide or any other ‘glow-in-the-dark’ material.

As described above, the self-illuminating canopy 10, i.e., the canopy body 12, can be fabricated from a phosphorescent or photoluminescent material, or from a plastic or compound that is integrally formed with or impregnated with (e.g., doped with) a phosphorescent or photoluminescent material, or by applying a phosphorescent or photoluminescent material as a layer or coating over a substrate. Furthermore, the canopy body 12, or the substrate thereof, can be fabricated using any suitable and desired manufacturing method such as injection molding, extrusion molding, compression molding, casting, material (e.g., metal) extrusion, material (e.g., metal) stamping, additive manufacturing, etc. Furthermore, the canopy body 12 can be fabricated to have any desired color and translucency. For example, in various embodiments the canopy body 12 can be fabricated to be opaque such that light will not penetrate or travel or radiate through the canopy body 12, while in other embodiments it is envisioned that the canopy body 12 can be translucent such light can penetrate or travel or radiate through canopy body 12. Moreover, since the canopy body 12 is fabricated from a phosphorescent or photoluminescent material, or from a plastic or compound that is integrally formed with or impregnated with (e.g., doped with) a phosphorescent or photoluminescent material, or by applying a phosphorescent or photoluminescent material as a layer or coating over a substrate, one skilled in the art would readily recognize that when the light source is removed and the canopy 10, i.e., the canopy body 12, is self-illuminating (e.g., generating, producing, radiating, discharging and/or exuding light without connection to an electrical source), the canopy 10 will self-illuminate from all sides, edges and surfaces of the canopy body 12. More specifically, when the light source is removed the canopy body 12 will self-illuminate from the top surface 12A, the bottom surface 12B, the first side edge/wall 12C, the second side edge/wall 12D, the front edge/wall 12E and the rear edge/wall 12F.

As described above, when exposed to a light source (e.g., sunlight or artificial light) the phosphorescent or photoluminescent material of canopy body 12 will absorb the light energy or radiation from the light source and reemit the energy or radiation in the form light for a considerable amount of time after the light source is removed such that the canopy 10, i.e., the canopy body 12, will self-illuminate or glow-in-the-dark. It is envisioned that in various embodiments, when the canopy 10 is ‘fully charged’ (i.e., when the phosphorescent or photoluminescent material of the canopy body 12 has absorbed light energy or radiation to a point of full saturation of the respective phosphorescent or photoluminescent material) the phosphorescent or photoluminescent material of the canopy body 12 is capable of self-illuminating (i.e., can generate, produce, radiate, discharge and/or exude light without direct connection (e.g., wired connection) to an electrical power source) for several hours, for example, 2 to 10 hours. As described above, in various embodiments the canopy body 12 can be constructed of a translucent material such that light (e.g., sunlight) will penetrate or travel or radiate through canopy body 12. In such instances the light will permeate throughout the thickness and entirety of the canopy body 12 and directly charge the entire canopy 10 including all sides and surfaces and all phosphorescent or photoluminescent material disposed internally within and throughout the thickness and entirety of the canopy body 12.

Moreover, it is envisioned that in various embodiments the phosphorescent or photoluminescent material can be selected such that it will fully charge within 2 to 6 hours, Hence, if the canopy 10 is attached to a golf cart, the canopy 10 will be fully charged, via the sun light, within the time frame of a round of golf, whereafter when the sun light expires, the canopy 10 will self-illuminate for several hours (e.g., 2 to 10 hours). Of course, as will be readily understood by one skilled in the art, the canopy 10 does not need to be fully charged to self-illuminate, but only be exposed to a light source long enough for the phosphorescent or photoluminescent material thereof to absorb and store sufficient energy to cause the phosphorescent or photoluminescent material to self-illuminate with the light source is removed. Hence, the longer the phosphorescent or photoluminescent material is allowed to ‘charge’ (i.e., absorb and store light energy or radiation), the longer the canopy 10 will self-illuminate with the light source is removed. The light source can be any natural light (e.g., sunlight) or artificial light (e.g., cast lighting such as light stanchions on streets, parking lots, golf courses, parks, etc., or light fixtures within a cart storage barn/shed or a garage). Furthermore, it is envisioned that the phosphorescent or photoluminescent material can be selected such that when the canopy 10 is fully charged the canopy 10 can self-illuminate with a lighting intensity, or luminosity, of approximately 300 or greater lumens (e.g., with a lighting intensity, or luminosity approximately equivalent to a 20 watt or greater incandescent light bulb). For example, in various embodiments the phosphorescent or photoluminescent material can be selected such that when the canopy 10 is fully charged the canopy 10 can self-illuminate with a lighting intensity, or luminosity, of approximately 300 to 1100 lumens (e.g., with a lighting intensity, or luminosity approximately equivalent to a 20 watt to 75 watt incandescent light bulb).

Of course, as one skilled in the art will readily recognize and understand, the self-illumination lighting intensity, or luminosity, of the canopy 10 will wane or slow decline as the light energy/radiation stored in the phosphorescent or photoluminescent material of the canopy body 12 is expelled and dissipates.

The self-illuminating canopy 10 can be utilized to provide various lighting features, functions, benefits and advantages of the respective vehicle 14 to which it is mounted without the need for, connection to, or utilization of an independent electrical power source such as the battery (battery pack) 66. For example, in various instances, the self-illuminating canopy 10 can be utilized to provide visibility or viewability of the respective vehicle 14 to pedestrians and other vehicle drivers after sunset and where there are few or no cast light sources (e.g., no streetlights). Additionally, in various instances, the self-illuminating canopy 10 can be utilized a light source or beacon to locate after sunset an incapacitated vehicle 14 that has been abandoned on a golf course, roadway, park, etc. In yet other instances, the self-illuminating canopy 10 can be utilized a light source to illuminate the passenger compartment 30 and area surrounding the vehicle 14 to interior and exterior ambient light for passenger convenience and safety.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. A canopy for a vehicle, said canopy comprising:
a body wherein the body is structured and operable to cover a portion of the vehicle and provide protection from rain, water or sunlight, the body comprising a photoluminescent material that is structured and operable to self-illuminate without a connection to an electrical power source.

2. The canopy of claim 1 wherein the photoluminescent material is integrally formed with the body.

3. The canopy of claim 1 wherein the photoluminescent material is a coating disposed over a substrate of the body.

4. The canopy of claim 1 wherein the photoluminescent material comprises strontium aluminate

5. The canopy of claim 1 wherein the photoluminescent material comprises copper-activated zinc sulfide.

6. The canopy of claim 1 wherein, when fully charged, the photoluminescent material is capable of self-illuminating for a period of 2 to 10 hours.

7. The canopy of claim 1 wherein the photoluminescent material is capable of self-illuminating with a light intensity of at least 300 lumens.

8. A canopy system for a vehicle, said canopy system comprising
at least one front strut;
at least one rear strut; and
a canopy that is mountable to the at least one front strut and the at least one rear strut, wherein the canopy comprises:
a body wherein the body is structured and operable to cover a portion of the vehicle and provide protection from rain, water or sunlight, the body comprising a photoluminescent material that is structured and operable to self-illuminate without a connection to an electrical power source.

9. The canopy system of claim 8 wherein the photoluminescent material is integrally formed with the body.

10. The canopy system of claim 8 wherein the photoluminescent material is a coating disposed over a substrate of the body.

11. The canopy system of claim 8 wherein the photoluminescent material comprises strontium aluminate

12. The canopy system of claim 8 wherein the photoluminescent material comprises copper-activated zinc sulfide.

13. The canopy system of claim 8 wherein, when fully charged, the photoluminescent material is capable of self-illuminating for a period of 2 to 10 hours.

14. The canopy system of claim 8 wherein the photoluminescent material is capable of self-illuminating with a light intensity of at least 300 lumens.

15. A vehicle, said vehicle comprising;
a chassis;
a plurality of wheels operatively connected to the chassis;
a passenger compartment supported by the chassis; and
a canopy system structured and operable to protect passengers of the vehicle from rain, water and sunlight, said canopy system comprising:
at least one front strut;
at least one rear strut; and
a canopy that is mountable to the at least one front strut and the at least one rear strut, wherein the canopy comprises:
a body wherein the body is structured and operable to cover a portion of the vehicle and provide protection from rain, water or sunlight, the body comprising a photoluminescent material that is structured and operable to self-illuminate without a connection to an electrical power source.

16. The vehicle of claim 15 wherein the photoluminescent material is integrally formed with the body.

17. The vehicle of claim 15 wherein the photoluminescent material is a coating disposed over a substrate of the body.

18. The vehicle system of claim 15 wherein the photoluminescent material comprises one of strontium aluminate and copper-activated zinc sulfide.

19. The vehicle of claim 15 wherein, when fully charged, the photoluminescent material is capable of self-illuminating for a period of 2 to 10 hours.

20. The vehicle of claim 15 wherein the photoluminescent material is capable of self-illuminating with a light intensity of at least 300 lumens.
